(19) United States
(12) Patent Application Publication
(10) Pub. No.: US 2019/0012609 A1
(43) Pub. Date: Jan. 10, 2019

(54) MACHINE LEARNING USING SENSITIVE DATA

(71) Applicant: BeeEye IT Technologies LTD, Binyamina (IL)

(72) Inventors: Tomer Fishler, Ramat Hasharon (IL); Assaf Binstock, Pardes Hana-Karkur (IL); Noam Hershtig, Haifa (IL); Sivan Rabinovich, Haifa (IL)

(21) Appl. No.: 15/643,009

(22) Filed: Jul. 6, 2017

(51) Int. Cl. G06N 99/00; G06F 21/60; G06F 21/62; G06N 5/04

(52) U.S. Cl. CPC G06N 99/005; G06N 5/04; G06F 21/6245; G06F 21/602

(57) ABSTRACT

A system, a computerized apparatus, a computer program product and a method performed in an environment comprising an on-premise system and an off-premise system, the on-premise system retaining records. Each record comprising a personal identifying information (PII) representing a person and data comprising sensitive data regarding the person. The identity of the person is obtainable from the PII but not from the data. The method comprising: obtaining, by the on-premise system, the PII of a record representing a person; providing at least a portion of the PII to the off-premise system, wherein the off-premise system is configured to obtain enriched data associated with the person; receiving, by the on-premise system, the enriched data from the off-premise system; and training a classifier using the data and the enriched data, wherein the classifier is being trained without relying on the personal identifying information.

### TECHNICAL FIELD

The present disclosure relates to machine learning in general, and to machine learning using sensitive data, in particular.

### BACKGROUND

Sensitive data encompasses a wide range of information and can include: ethnic or racial origin; political opinion; physical or mental health details; personal life; criminal or civil offences; and the like. Sensitive data can also include information that relates to consumers, clients, employees, patients, students or the like. In some cases, sensitive data is accompanied by identifying information of the person to which the sensitive data relates, such as contact information, identification numbers, birth date, username, email address, social security number, bank account number, aliases, or the like.

Financial institutions that provide financial services for their clients, such as banks, credit unions, trust companies, mortgage loan companies, insurance companies, pension funds, brokerage firms, or the like, may retain a great deal of sensitive data of their clients. Organizations dealing with sensitive data, and especially financial institutions, make substantial efforts to protect the sensitive data the organizations use. Most of such organizations are regulated by the government, which may supervise that the sensitive data is not misused, divulged, leaked, risked, or the like. In many cases, the organizations undertake strict obligations as part of their privacy policy and based on state regulations. Technological measurements are put in place to preserve and protect the privacy of the sensitive data. However, such sensitive data is sometimes needed for data processing purposes of the organization.

### BRIEF SUMMARY

One exemplary embodiment of the disclosed subject matter is a method performed in an environment comprising an on-premise system and an off-premise system, wherein the on-premise system retaining records, each of which comprises a personal identifying information and a data, wherein an identity of a person represented by a record is obtainable from the personal identifying information of the record, wherein the data comprising sensitive data regarding the person, wherein the identity of the person is not obtainable from the data, wherein the method comprising: obtaining, by the on-premise system, the personal identifying information of a record representing a person; providing at least a portion of the personal identifying information of the record to the off-premise system, wherein the off-premise system is configured to obtain enriched data associated with the person; receiving, by the on-premise system, the enriched data from the off-premise system; and training a classifier using the data and the enriched data, wherein the classifier is being trained without relying on the personal identifying information.

Optionally, the method further comprising: encrypting, in the off-premise system, the enriched data to obtain an encrypted data; and wherein said receiving comprises receiving the encrypted data, whereby the enriched data in a non-encrypted form is not obtainable by unauthorized entities within the on-premise system.

Optionally, the method further comprising: deriving, by the off-premise system, a feature from the enriched data; and providing the feature to the on-premise system, wherein the feature is provided in a non-encrypted form.

Optionally, the on-premise system is associated with an organization, wherein the on-premise system executing entities associated with the organization, wherein the on-premise system executing entities associated with a vendor, wherein the off-premise system is associated with the vendor, and wherein entities associated with the vendor are authorized entities, wherein entities associated the organization are unauthorized entities.

Optionally, said training is performed by an authorized entity, wherein said training comprises decrypting the encrypted data, and utilizing the non-encrypted form of the enriched data in combination with the data to train the classifier.

Optionally, the method further comprising: wherein said training is performed by a second off-premise system; in response to said training, obtaining, by the on-premise system, the classifier, wherein the on-premise system is configured to utilize the classifier to predict a label for a person.

Optionally, the second off-premise system is the off-premise system.

Optionally, the method further comprising: utilizing the classifier, by the on-premise system, to predict a label for a second person represented by a second record, wherein the second record comprising a second personal identifying information and a second data, wherein said utilizing comprises: providing at least a portion of the second personal identifying information to the off-premise system to obtain a second enriched data; determining, by the classifier and based on the second data and the second enriched data, the label for the second person.

Optionally, said providing the at least a portion of the personal identifying information comprises providing a proper subset of the personal identifying data.

Optionally, the off-premise system comprises a plurality of engines, each of which is configured to obtain a portion of the enriched data based on a different proper subset of the personal identifying information.

Optionally, the off-premise system is restricted from storing the personal identifying information.

Optionally, the off-premise system is configured to obtain the enriched data from publicly available information sources accessible via the Internet.

Another exemplary embodiment of the disclosed subject matter is a computerized apparatus having a processor, wherein the apparatus retaining records, each of which comprises a personal identifying information and a data, wherein an identity of a person represented by a record is obtainable from the personal identifying information of the record, wherein the data comprising sensitive data regarding the person, wherein the identity of the person is not obtainable from the data, wherein the processor being adapted to perform the steps of: obtaining personal identifying information of a record representing a person; providing at least a portion of the personal identifying information of the record to an off-premise system, wherein the off-premise system is configured to obtain enriched data associated with the person; receiving the enriched data from the off-premise system; and training a classifier using the data and the enriched data, wherein the classifier is being trained without relying on the personal identifying information.

Optionally, the processor is further adapted to perform the steps of: encrypting, in said off-premise system, the enriched data to obtain an encrypted data; and wherein said receiving comprises receiving the encrypted data, whereby the enriched data in a non-encrypted form is not obtainable by unauthorized entities within said computerized apparatus.

Optionally, the processor is further adapted to perform the steps of: deriving, by said off-premise system, a feature from the enriched data; and providing the feature to the computerized apparatus, wherein the feature is provided in a non-encrypted form.

Optionally, the computerized apparatus is associated with an organization, wherein the computerized apparatus executing entities associated with the organization, wherein said computerized apparatus executing entities associated with a vendor, wherein said off-premise system is associated with the vendor, and wherein entities associated with the vendor are authorized entities, wherein entities associated the organization are unauthorized entities.

Optionally, said training is performed by an authorized entity, wherein said training comprises decrypting the encrypted data, and utilizing the non-encrypted form of the enriched data in combination with the data to train the classifier.

Optionally, the processor is further adapted to perform the steps of: utilizing the classifier to predict a label for a second person represented by a second record, wherein the second record comprising a second personal identifying information and a second data, wherein said utilizing comprises: providing at least a portion of the second personal identifying information to said off-premise system to obtain a second enriched data; determining, by the classifier and based on the second data and the second enriched data, the label for the second person.

Yet another exemplary embodiment of the disclosed subject matter is a system comprising said computerized apparatus and said off-premise system.

Yet another exemplary embodiment of the disclosed subject matter is a computer program product comprising a non-transitory computer readable storage medium retaining program instructions, which program instructions when read by a processor, cause the processor to perform a method comprising: obtaining, by an on-premise system, personal identifying information of a record representing a person, wherein the on-premise system retaining records, each of which comprises a personal identifying information and a data, wherein an identity of a person represented by a record is obtainable from the personal identifying information of the record, wherein the data comprising sensitive data regarding the person, wherein the identity of the person is not obtainable from the data; providing at least a portion of the personal identifying information of the record to an off-premise system, wherein the off-premise system is configured to obtain enriched data associated with the person; receiving the enriched data from the off-premise system; and training a classifier using the data and the enriched data, wherein the classifier is being trained without relying on the personal identifying information.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a schematic illustration of an exemplary environment and architecture in which the disclosed subject matter may be utilized, in accordance with some exemplary embodiments of the disclosed subject matter; and

FIGS. 2A and 2B show flowchart diagrams of methods, in accordance with some exemplary embodiments of the disclosed subject matter.

### DETAILED DESCRIPTION

One technical problem dealt with by the disclosed subject matter is to enable organizations dealing with sensitive data to work with external vendors, without revealing the sensitive data.

In some exemplary embodiments, financial institutions, or other organizations dealing with sensitive data, such as health organizations, detention systems, governmental organizations, or the like, may be designated to process the sensitive data they possess, to extract additional value or data, to enrich the data, or the like. In order to process and extract more value from the sensitive data an organization possess, the organization may employ a large team of data experts, statisticians and other data related experts. The need for highly advanced methods and diverse expertise which may be beyond the scope of the local teams of the organization is ever growing. The organization may work with external vendors to perform the analytics and the additional data extraction. The external vendors may have advanced analysis techniques, large resources, required experts, access to other available sources of information, or the like. The external vendors may use technologies and resources that the organization does not have access to, services that the organization does not provide, or the like. The external vendors may be able to enrich the data of the organization in a relatively short time, in an efficient manner, in a manner providing added information of relative high value, or the like. However, sharing the sensitive data of the organizations with external vendors may be associated with the risk of data leakage. The organizations may be required to maintain the confidentiality of the sensitive data, and avoid revealing the data, even to vendors that are supposed to process the data itself.

Another technical problem dealt with by the disclosed subject matter is to provide a prediction model for an organization dealing with sensitive data, which predicts labels based on sensitive data, without compromising the privacy of the people whose sensitive data is being used. The predicted labels may indicate answers to business questions of interest to the organization. In some exemplary embodiments, the organization may use a classifier that is able to label records based on internal requirements of the organization. The classifier may utilize the prediction model to make its prediction. The classifier may be required to be adapted to the data of the organization. To provide for a reliable and useful prediction, data records may be enriched with additional data that could be useful for the prediction, such as data obtainable from the public web, from social media, or the like. In some cases, it may be preferred that the training be performed by an external vendor, such as having substantial resources available for such a task. In some cases, the model training may be semi-automatic and may include using data engineers to review the data and assist in optimizing the prediction model based on their manual analysis.

Yet another technical problem is compartmentalization of the enriched data that is used for training the prediction model or for performing the prediction. In case the training and the prediction are performed by an external vendor or using the services of such vendor, the vendor may wish to compartmentalize the enriched data it obtains for such tasks, and avoid divulging it to the organization. By preventing its client, the organization, from gaining access to the enriched data, the external vendor may mitigate the risk of being replaced by another vendor or by an internal team of the organization after providing initial information to the organization.

One technical solution is to utilize external vendors for the enrichment of the data without disclosing sensitive data of the organization. In some exemplary embodiments, the organization may provide only portions of the data to the external vendor that are required to obtain the enriched data. The organization may avoid sharing sensitive data of its clients. Instead, the organization may provide minimal identifying information of its clients to the external vendor. The minimal identifying information may not comprise sensitive data of the client, but would be sufficient to obtain additional information about the client.

Another technical solution is to provide anonymized data to the external vendor for classifier training purposes. In some exemplary embodiments, the sensitive data, when separated from Personal Identifying Information (PII) of the person, may not be useful to distinguish individual identity. For example, the sensitive data may include a shopping history, allocation of financial assets, outstanding loans, balance in the checking account, or the like. Such sensitive data is not, by itself, useful to identify the person to which it relates, if no PII is provided together with the sensitive data. The organization may anonymize the data by separating sensitive data from the PII that can be used to identify the person. The external vendor may use the anonymized data to train the classifier without being exposed to the identity of the person.

Yet another technical solution is to encrypt the enriched data that was obtained by the external vendor. The vendor may supply the encrypted data to the organization which may not be able to decrypt it back to non-encrypted form. As a result, the data may be retained internally on the premises of the organization, within its data repositories, but cannot be used without the external vendor's permission. In some cases, the organization may execute a computer program product of the vendor which is capable of decrypting and utilizing the enriched data for its intended purposes, such as for providing the enriched data together with anonymized sensitive data to a training module or to a trained classifier.

Additionally or alternatively, the vendor may supply a derived feature that is based on the enriched data. The derived feature may summarize the enriched data, may provide an abstraction thereof, or the like. For example, the derived feature may be a credit score of the person associated with the data based on the enriched data. The derived feature or features may be provided to the organization in a non-encrypted form, allowing the organization to use the derived feature. Additionally or alternatively, the encrypted enriched data and the non-encrypted derived features may be transmitted together to the organization and stored in tandem with the sensitive data of the person to which they refer in the data repository of the organization.

In some exemplary embodiments, the external vendor may operate, at least in part, off the premises of the organization. The external vendor may utilize an off-premise system for enriching the data, such as a Software-as-a-Service (SaaS) system, a cloud computing system, or the like. The off-premise system may be installed and executed at a remote facility such as a server farm, in the cloud, or the like, reachable via a computerized network such as the Internet. The off-premise system may not have access to data retained on premises of the organization.

In some exemplary embodiments, the organization may retain its data in an on-premise system thereof. The on-premise system may be installed and executed on computers within the logical premises of the organization. The on-premise system may comprise an in-house server, computing infrastructures, or the like. The on-premise system may be controlled by the organization. The on-premise system may be administrated by a member of the organization. The on-premise system may utilize the organization's computing resources to provide computational functions for the organization. The on-premise system may be configured to execute entities associated with the organization, such as programs provided with permissions to be executed in the on-premise system. In some cases, entities associated with external entities, such as vendors, may also be executed by the on-premise system. The organization may be responsible for the security, availability and overall management of on-premises system.

It will be noted that terms “on-premise” and “off-premise” used in the present disclosure are used to provide a logical distinction and not a physical one. A system may be referred to as “on-premise” even if some or all of the computers comprised by it are located in remote locations, as long as they are controlled by the organization. In some cases, the on-premise systems may be included within a local network of the organization, such as an intranet, and may not involve external networks, such as the Internet, other LAN networks, or the like. The organization may be in control of devices in the on-premise system and may consider data retained therein as retained by the organization itself and not retained by a third party.

In some exemplary embodiments, the data may be retained as records comprising PII and data. Each record may be associated with a person, such as a customer of the organization, a citizen, a subject, or the like. An identity of the person represented by the record may be obtainable from the PII of the record, or portion thereof. The PII may comprise a name of the person, home address, E-mail address, identification number, such as an ID number, a passport number, a social security number, driving license number, or the like; date or place of birth; biometric records, such as face, fingerprints, or handwriting, or the like; vehicle registration plate number; credit card numbers; genetic information; login name; alias; telephone number; or the like.

In some exemplary embodiments, the data of the record may comprise sensitive data regarding the person. It may be appreciated that the identity of the person may not be obtainable from the data. In some exemplary embodiments, the sensitive data may comprise information that is linked or linkable to the individual, such as medical, educational, financial, employment information, or the like. As an example, a user's IP address may not be considered as PII on its own, but if linked with a PII may be classified as sensitive data that if not being kept confidential may result in harm to the person whose privacy is being breached. Additional examples of sensitive data may be grades, salary, job position, criminal record, Web cookie, purchase history, past locations, financial status, employment history, or the like.

In some exemplary embodiments, the on-premise system may divide the PII into proper subsets of data. As an example, the PII may be divided into two subsets, the first comprising a name of the person and the second comprising an ID number of the person. The on-premise system may provide one or more of the proper subsets of the PII to the off-premise system. The off-premise system may be configured to obtain enriched data associated with the person based on the PII or parts thereof. It may be appreciated that the off-premise system may comprise a plurality of engines. Each engine may be configured to obtain a portion of the enriched data based on a different proper subset of the PII. The on-premise system may be configured to provide to each engine the relevant proper subset of the PII that is used by that engine. It will be noted that the proper subsets may or may not be disjoint groups. In some cases, a same PII field may be comprised by several different proper subsets.

It may be appreciated that providing different proper subsets of the PII to different engines, may constitute as an additional security protection layer. If certain web data is collected using only one proper subset of the PII, such as the ID of a person in a record, only the ID will be sent in to the off-premise system to extract this certain piece of data. An adversary or a malicious party that obtained an access to the channel of communication between the on-premise system and the off-premise system, or which monitors the activities of the off-premise system when consulting with external data sources, such as web search engines, may not be able to reconstruct the full PII from the individual proper subset thereof. In some exemplary embodiments, each engine is provided with its relevant proper subset. Combining the different proper subsets to recreate the PII may require the adverse party to be able to correlate between the proper subsets of the same record. Such correlation may not be possible in case of disjoint proper subsets.

In some exemplary embodiments, the off-promise system may be configured to obtain the enriched data from publicly available information sources accessible via the Internet. As an example, the off-premise system may obtain the enriched data of the person based on social network profile of the person, based on web search results of the PII of the person, based on public web sources, based on query engines, such as a credit score check, based on government data sets, based on offline resources such as newspapers, external offline data repositories (e.g., retained in external Compact Discs Read-Only Memory (CD ROMs)), or the like. The off-premise system may provide the enriched data to the on-premise system. It may be appreciated that the off-premise system is restricted from storing the PII. Additionally or alternatively, the off-premise system may be restricted from storing the per-record enriched data. Such restrictions may also mitigate the risk of data leakage.

In some exemplary embodiments, the off-premise system may provide the enriched data to the on-premise system. Additionally or alternatively, the off-premise system may be configured to encrypt the enriched data prior to providing the enriched data to the on-premise system. The off-premise system may provide the encrypted form of the enriched data to the on-premise system. The non-encrypted form of the enriched data may not be accessible to unauthorized entities, such as unauthorized entities within the on-premise system, entities associated with the organization, or the like. In some exemplary embodiments, the on-premise system may be configured to execute entities associated with a vendor associated with the off-premise system. Entities associated with the vendor may be authorized entities, and may have access to the non-encrypted form of the enriched data, such as entities trusted with the task of processing said data, such as for preparing anonymized training data, providing anonymized data for a label prediction query, or the like.

In some exemplary embodiments, the off-premise system may be configured to derive a feature from the enriched data and provide such feature in a non-encrypted form. As an example, a financial institution may work with an external vendor to obtain Probability of Default (PD) parameter for its clients. The PD parameter may describe the likelihood of a credit default over a particular time horizon. The PD parameter may provide an estimate of the likelihood that a borrower, e.g., a potential client of the financial institution, will be unable to meet its debt obligations. The PD parameter may be associated with financial characteristics of the borrower, such as inadequate cash flow to service debt, declining revenues or operating margins, high leverage, declining or marginal liquidity, and the inability to successfully implement a business plan, or the like. The PD parameter may further depend on other non-quantifiable factors that may estimate the borrower's willingness to repay. The financial institution may have for each customer's record two types of data, PII and financial data. The financial data may be considered as sensitive only if it is combined with the PII. Sharing the financial data as anonymous data may not risk the confidentiality of the data. The financial institution may retain the customer records in an on-premise database. An on-premise system of the financial institution may separate the PII of each customer into proper subsets, each of which to be provided to a different engine. Each engine may be configured to receive different PII information. Each engine may be configured to obtain enriched data from one or more external sources. As an example, one engine would require the person's social security number, another engine would require the person's username on one social media site, another engine would require the person's username on another social media site, another engine would require the person's full name, etc. The on-premise system may provide the proper subsets to off-premise system that is associated with the external vendor. In some exemplary embodiments, the off-premise system may comprise the plurality of engines. The off-premise system may obtain enriched data associated with the PII or portions thereof. The off-premise system may calculate an initial PD parameter of the customer based on the enriched data and without relying on the financial data available to the financial institution. The off-premise system may encrypt the enriched data. The off-premise system may provide the initial PD parameter in a non-encrypted form along with the encrypted enriched data to the on-premise system. The initial PD parameter may be available to entities of the organization. As an example, the organization may use the initial PD parameter and combine it with the financial data available thereto, to compute the PD parameter. The encrypted enriched data may be retained by the on-premise system of the organization, however, only authorized entities may be able to decrypt the encrypted enriched data and make use thereof, such as for learning purposes. Therefore, the organization may not be able to use the enriched data without the assistance of the external vendor (e.g., without using the external vendor's software). In some cases, after the enrichment of the data, the off-premise system may delete the PII and avoid retaining it, such that no PII related residuals are left on the on-premise system. In some exemplary embodiments, the PII is never retained in persistent storage, and is only available in volatile memory such as RAM memory, for computation purposes only. In some cases, the enriched data is also deleted to mitigate the risk of identifying the person based on the enriched data itself.

In some exemplary embodiments, a classifier may be trained based on the data and the enriched data. The classifier may be trained without relying on and without having access to the PII. In some exemplary embodiments, the training may be performed by an authorized entity, such as an entity of the external provider. The authorized entity may be configured to decrypt the encrypted data to obtain a decrypted form thereof. The authorized entity may utilize the decrypted form in combination with the data to train the classifier.

Additionally or alternatively, a second off-premise system may be configured to train the classifier based on the data and the enriched data. The second off-premise system may obtain the enriched data from the off-premise system, and the data from the on-premise system, without the PII. Exposing the data without the PII may not be considered as a breach of the organization's privacy policy (be it voluntary or mandatory). Additionally or alternatively, the training may be performed in the same off-premise system where enrichment is performed. In such a case, the enriching phase and the training phase may be separated, so as the PII and the data may not be provided together to the off-premise system, such as via different engines, via separate interfaces (e.g., different API functions), or the like. Additionally or alternatively, the training dataset may be gathered by the on-premise system. In some exemplary embodiments, there may be no data exchange between an enrichment module of the off-premise system which is in charge of the enriching phase, and between a training module which is in charge of the training phase, even when both modules are deployed on a same off-premise system.

In some exemplary embodiments, the classifier may be trained using supervised machine learning. The authorized entity may be presented with example inputs and their a-priori known labels. In some exemplary embodiments, the labels may be obtained based on actual observed performance. As an example, considering the example of the PD parameter again, the label may be DEFAULT or NOT-DEFAULT. The set of records regarding people who have previously taken loans may be used together with the observed actual result. In some cases, the data of the records may be augmented using engines to obtain enriched data. Additionally or alternatively, the enriched data may have been obtained at a different time than the time in which the result was observed. For example, the enriched data may be obtained at the time the loan was taken. Based on the observed result, labels are assigned to anonymized records comprising the data and the enriched data. The classifier may be trained based on such training set to predict labels for other records. The confidence measurement may be used to derive a PD parameter based on the predicted label (e.g., PD=100%*confidence in DEFAULT label; PD=100%*(1−confidenece in NOT-DEFAULT label)). In some exemplary embodiments, the training process may be fully automatic, semi-manual or the like. In some cases, data scientists may be employed to improve the prediction model based on their manual analysis of the data available thereto. In order to maintain the organization's privacy policy, the training data provided for training purposes may be anonymized and devoid of any PII.

In some exemplary embodiments, the trained classifier may be provided to the on-premise system, such as by transmitting an executable thereof, sending the prediction model to be loaded by an executable that is present in the on-premise system, or the like. The on-premise system may be configured to utilize the classifier to predict a label for a person. In order to predict a label, the on-premise system may provide PII or portion thereof to the off-premise system to obtain enriched data, which may be encrypted. The encrypted enriched data and the sensitive data available in the on-premise system for the same person, may be combined together and provided to the classifier. The classifier may decrypt the encrypted enriched data and utilize the enriched data and the sensitive data to predict the label for the person.

One technical effect of utilizing the disclosed subject matter is to enable a third party to train a prediction model based on sensitive data, without breaching the privacy of people associated with the sensitive data. The sensitive data is enriched based on PII of the people correspondingly with the people identity. The third party may utilize the enriched data along with relevant sensitive data associated with the same person for the training of the prediction model, without knowing the identity of the person.

Another technical effect of utilizing the disclosed subject matter is to enable external vendors to utilize the enriched data they collect without risking the confidentiality of the sensitive data of the organization. During the enrichment process, the off-premise system associated with the external vendor, may act as a proxy, and may work without any local database. In some embodiments, no data is kept about the original records on the side of the external vendor. On the other hand, the external vendor provides the enriched data in an encrypted form, while the on-premise system pairs the enriched data with anonymized sensitive data, without knowing the content of the enriched data, and without exposing identity of the person associated with the sensitive data. The external vendor may expose only a portion of the enriched data to the organization, such as a calculated feature derived from the raw enriched data. The external vendor may encrypt the raw data portion of the enriched data, thereby preventing access to unauthorized entities while enabling such enriched data be used later after being paired with the relevant anonymized sensitive data, for learning purposes or for prediction purposes.

The disclosed subject matter may provide for one or more technical improvements over any pre-existing technique and any technique that has previously become routine or conventional in the art.

Additional technical problem, solution and effects may be apparent to a person of ordinary skill in the art in view of the present disclosure.

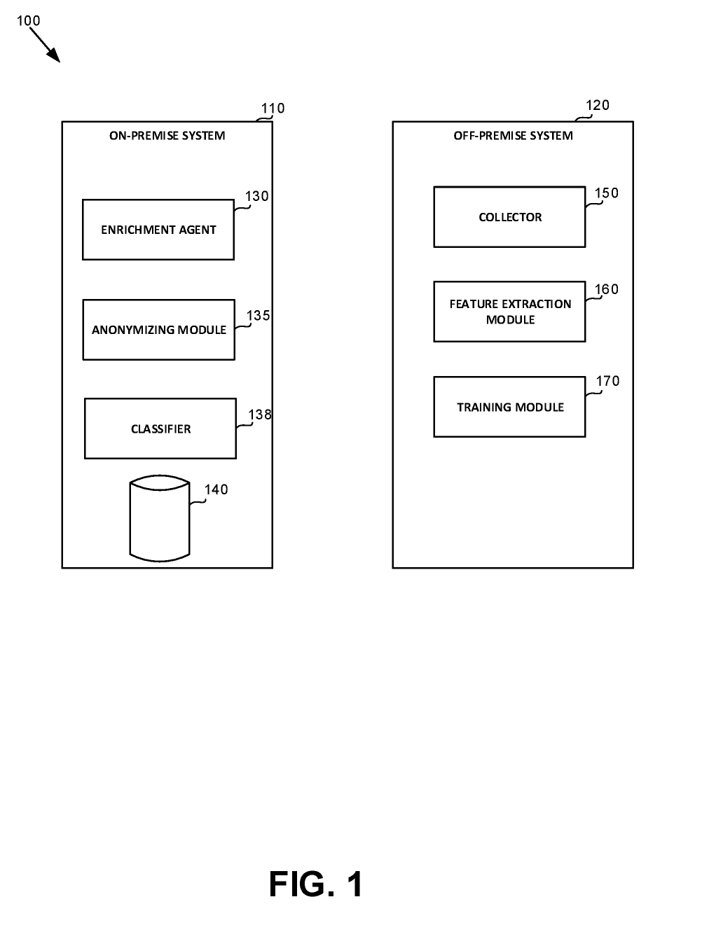

Referring now to FIG. 1 showing a schematic illustration of an exemplary environment and architecture in which the disclosed subject matter may be utilized, in accordance with some exemplary embodiments of the disclosed subject matter.

An Environment 100 comprises an On-Premise System 110 and an Off-Premise System 120. In some exemplary embodiments, On-Premise System 110 may be associated with an organization. Information Technology (IT) staff of the organization may have access to On-Premise System 110 and can directly control the configuration, management and security of the computing infrastructure and data of On-Premise System 110.

In some exemplary embodiments, On-Premise System 110 may be configured to retain records in a Database 140. Each record may be associated with a person, such as a member of the organization, a client, or the like. Each record may comprise a PII of the person represented by the record and a data associated with the person. The identity of the person represented by the record may be obtainable from the PII of the record. The data of the record may comprise sensitive data regarding the person. The identity of the person may not be obtainable from the data. In combination with the PII, when the identity of the person is known or is obtainable, the data may be considered to be confidential.

Off-Premise System 120 may be a computing system controlled by a vendor providing a service to the organization. Off-Premise System 120 may be located outside the control of the organization. As an example, Off-Premise System 120 may be a remote server, such as executed in the cloud, accessible over the Internet, or the like.

In some exemplary embodiments, an Enrichment Agent 130 of On-Premise System 110 may have access to a Database 140. Enrichment Agent 130 may be a server, a computing device, a software agent being executed by a device, or the like. In some exemplary embodiments, Enrichment Agent 130 may be configured to assist in enriching a record in Database 140. Enrichment Agent 130 may be configured to obtain a PII of a record representing a person, for which enriched data is desired, from Database 140.

In some exemplary embodiments, Enrichment Agent 130 may be configured to query a Collector 150 to obtain the enriched data. Enrichment Agent 130 may provide a PII or portion thereof to Collector 150. Collector 150 may then utilize the PII or portion thereof to obtain additional data regarding the person identified by the PII. In some exemplary embodiments, Collector 150 may not be provided with any of the data retain in the record except for the PII. Additionally or alternatively, a plurality of Collectors 150 may be employed, each of which may be configured to obtain enriched data from a different external source. Each Collector 150 may be provided with a different portion of the PII, such as a proper subset of the PII. In some exemplary embodiments, Enrichment Agent 130 may be configured to determine one or more proper subsets of the PII, which may or may not be disjoint, to be provided to the different Collectors 150.

In some exemplary embodiments, Collector 150 may be configured to obtain the enriched data from publicly available information sources accessible via the Internet. As an example, Collector 150 may obtain the enriched data from data published by governments or international organizations. As another example, Collector 150 may obtain the enriched data from social networks, using online search engines, from public web sources, from government data sets, from offline resources, or the like.

In some exemplary embodiments, Off-Premise System 120 may be restricted from storing the PII or the enriched data.

In some exemplary embodiments, Collector 150 may be configured to encrypt the enriched data. The enriched data may be encrypted in a way that only authorized parties can access it. The encryption may be performed using an encryption algorithm, such as utilizing an encryption key to encrypt the enriched data. The encryption key may be utilized to decrypt the encrypted data and reconstruct the enriched data in a non-encrypted form. The key may be accessible only to authorized entities, such that the enriched data is not accessible to unauthorized entities.

In some exemplary embodiments, Collector 150 may transmit encrypted data to Enrichment Agent 150.

In some exemplary embodiments, a Feature Extraction Module 160 in Off-Premise System 120, may be configured to derive a feature from the enriched data collected by Collector 150. The feature may be associated with the person and be representative of a characteristic thereof or estimation regarding the person. The feature may be determined based on requirements of the organization, such as based on parameters, equations, rules, or the like, provided by On-Premise System 110. In some exemplary embodiments, the feature may be derived from the output of a single Collector 150. Additionally or alternatively, the feature may be derived from output of several Collectors 150 which are combined together. In order for the output of the several Collectors 150 to be used together, there must be some correlation between the portions of the PIIS that they are provided with. Additionally or alternatively, Feature Extraction Module 160 may be located in On-Premise System 110 and be configured to derive the feature based on an augmented record retained in Database 140.

In some exemplary embodiments, Off-Premise System 120 may be configured to provide the encrypted data and the feature to On-Premise System 110. Enrichment Agent 130 may be configured to obtain the responses to its queries, and correlate them together to the original record, so as to add new fields to the existing record, thereby creating an augmented record. In some exemplary embodiments, the augmented record may comprise the PII, the data, the encrypted enriched data and the non-encrypted feature. Additionally or alternatively, some or all of the added data may be retained in a different database than Database 140 (not shown).

In some exemplary embodiments, Anonymizing Module 135 may be configured to obtain augmented record, such as from Database 140, from Enrichment Agent 130, or the like. Anonymizing Module 135 may be configured to obtain the augmented record and remove the PII therefrom. The anonymized augmented record may be provided to a Classifier 138 for label prediction, to a Training Module 170 for classifier training, or the like. In some exemplary embodiments, Anonymizing Module 135 may batch process a bulk of records and provide such records, with observed labels thereof, as a training dataset to Training Module 170. The observed labels may be obtained based on the data available in Database 140. As an example, the data may indicate whether or not a client had paid back a loan she took. Based on such observed behavior, a DEFAULT or NO-DEFAULT label may be determined. Additionally or alternatively, the label may be a value determined based on the data available in Database 140, based on a determination by an authorized entity of On-Premise System 110, or the like.

In some exemplary embodiments, Training Module 170 may be configured to train a classifier using the data and the enriched data. In some exemplary embodiments, Training Module 170 may train the classifier in a fully automatic manner. Additionally or alternatively, data scientists may take part in the optimization of the prediction model, such as by manually analyzing the training dataset. Data scientists may improve an automated prediction model, such as by introducing additional formulas, relaying on combination of features, or using any insights they may have on the training dataset. Training Module 170 may be configured to train the classifier without relying on the PII. In some exemplary embodiments, Anonymizing Module 135 may be configured to pair the encrypted data with the respective data associated with the PII. Anonymizing Module 135 may be configured to provide pairs of encrypted data and data, and a label for each pair for Training Module 170.

In some exemplary embodiments, Training Module 170 may configured to train a prediction model useful by a classifier. Once the prediction model is determined, Training Module 170 may provide Classifier 138 to On-Premise System 110. On-Premise System 110 may be configured to utilize Classifier 138 to predict a label for a person. To determine a label for a specific person, Enrichment Agent 130 may be configured to provide the PII of the specific person to Collector 150 to obtain enriched data. On-Premise System 110 may determine using Classifier 138 and based on the data of the specific person and the enriched data, the label for the specific person. In some exemplary embodiments, as the enriched data may be decrypted, Classifier 138, or another processing entity provided by the vendor, such as Anonymizing Module 135, may decrypt the enriched data to be used in its non-encrypted form for prediction.

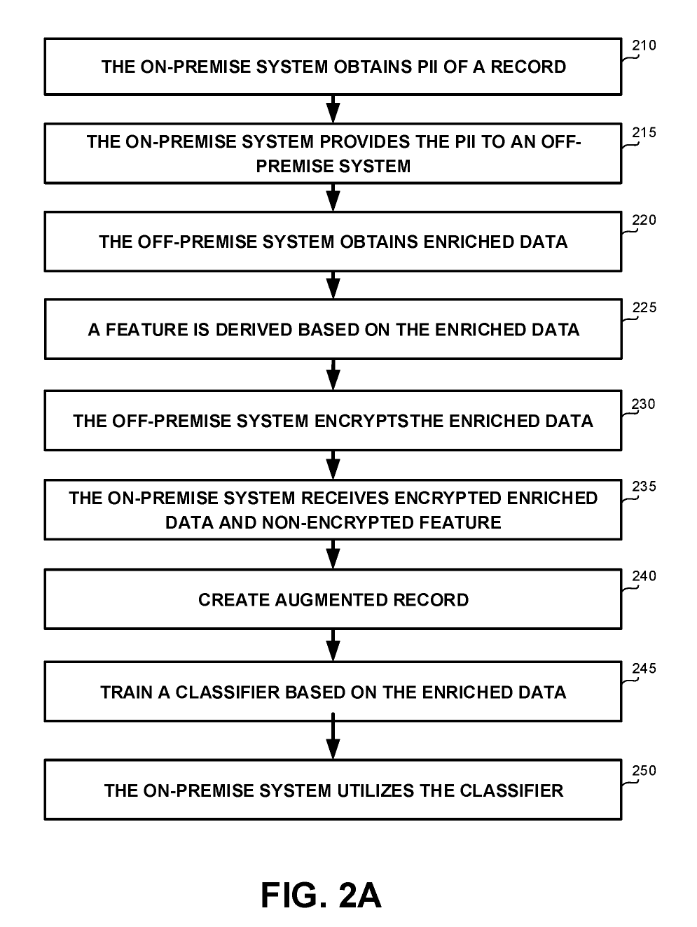

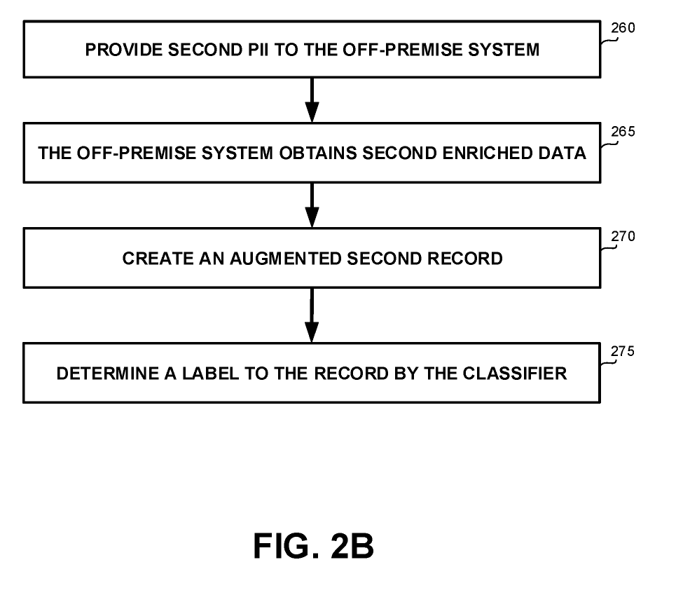

Referring now to FIG. 2A showing a flowchart diagram of a method, in accordance with some exemplary embodiments of the subject matter.

On Step 210, an on-premise system, such as 110 of FIG. 1, may obtain a PII of a record. In some exemplary embodiments, the record may comprise a PII and a data. The record may represent a person. An identity of the person represented by the record may be obtainable from the PII. The data of the record may comprise sensitive data regarding the person. The identity of the person may not be obtainable from the data.

On Step 215, the on-premise system may provide the PII, or portion thereof, to an off-premise system, such as 120 of FIG. 1. In some exemplary embodiments, the on-premise system may provide the PII as whole to the off-premise system. Additionally or alternatively, the on-premise system may provide the one or more proper subsets of the PII to the off-premise system. Additionally or alternatively, different proper subsets of the PII may be provided to deferent instances of the off-premise system or to different collector engines employed thereby. As an example, the off-premise system may comprise a plurality of engines. Each engine may be configured to obtain a portion of the enriched data based on a potentially different proper subset of the personal identifying information, such as using different sources of information.

On Step 220, the off-premise system may obtain enriched data associated with the PII. In some exemplary embodiments, the off-premise system may be configured to obtain the enriched data, using collector engines, from publicly available information sources accessible via the Internet. As an example, the off-premise system may search for the PII in web search engines that are designed to search for information on the World Wide Web. The off-premise system may utilize the search results to generate the enriched data.

On Step 225, a feature may be derived from the enriched data. In some exemplary embodiments, the feature may be a value of a parameter associated with the person represented by the record. As an example, the feature may be a likelihood of a diagnostic testing of the person. As an additional example, the feature may be an affordable premium that is calculated based on the likelihood of an insured event, the cost of the event, or the like. As yet another example, the feature may be an engagement feature describing the engagement of the person in social media as a whole or with respect to specific topics. The feature may be evaluated based on the enriched data, and based on rules, conditions, formulas or the like. In some exemplary embodiments, the feature may be derived in the off-premise system. Additionally or alternatively, the feature may be derived in the on-premise system

On Step 230, the off-premise system may encrypt the enriched data. In some exemplary embodiments, a non-encrypted form of the enriched data may not be obtainable by unauthorized entities within the on-premise system, entities associated with the organization, malicious parties, or the like. In some exemplary embodiments, the on-premise system may execute entities associated with a vendor that is associated with the off-premise system. Entities associated with the vendor may be authorized entities and may have access to a decryption module useful for decrypting the encrypted enriched data, such as a private key used for decryption. Authorized entities may be configured to decrypt the encrypted data to obtain a non-encrypted form of the enriched data. As an example, the off-premise system may provide the key utilized in encrypting the enriched data for the authorized entities. In some exemplary embodiments, authorized entities may have access to the raw enriched data, while unauthorized entities may not have access to raw data. In some cases, the unauthorized entities may only have access to the derived features, which were derived based on the raw enriched data.

On Step 235, the off-premise system may provide the encrypted enriched data to the on-premise system. Additionally or alternatively, the derived feature may be provided to the on-premise system, in a non-encrypted form. In some exemplary embodiments, the off-premise system may be required to delete the PII and the enriched data after providing them to the on-premise system. The off-premise system may be configured to work without any local database, thereby preventing the off-premise system from storing such data.

On Step 240, the encrypted enriched data is paired with the relevant record, to create an augmented record. The relevant record may be the record from which the PII was obtained on Step 215. The augmented record may be retained in the on-premise system. The augmented record may comprise the PII, the data, the derived feature, the encrypted enriched data, or the like. In some exemplary embodiments, the augmented record may be used by different entities executed within the on-premise system. However, only authorized entities may be able to utilize the enriched data, as only such entities may be able to decrypt the encrypted enriched data.

On Step 245, a classifier may be trained using the enriched data. In some exemplary embodiments, the augmented record may be anonymized by removing the PII therefrom. Additionally or alternatively, an observed label for the augmented record may be obtained. The anonymized augmented records together with their respective labels may be used as a training dataset for training a predictive model of a classifier. The classifier may be trained without relying on the PII. In some exemplary embodiments, the training dataset used for training may comprise the non-encrypted form of the enriched data. The encrypted enriched data may be decrypted by an authorized entity, such as an anonymizing module (e.g., 135 of FIG. 1), a training module (e.g., 170 of FIG. 1), or the like. Additionally or alternatively, the classifier may be trained by the off-premise system, a second off-premise system, or the like. The on-premise system may provide the training dataset to the off-premise system.

In some exemplary embodiments, the training may be performed fully automatically. Additionally or alternatively, the training may be performed manually or semi-automatically, such as with the assistance of data scientists that may provide hints, heuristics, insights, or the like, which may be useful in determining an optimized prediction model for the classifier.

On step 250, the on-premise system may utilize the classifier to determine labels for enriched records. In some exemplary embodiments, in response to training the classifier, the on-premise system may obtain the classifier. The on-premise system may retain the classifier and utilize it classifier to predict a label for a person, such as depicted on FIG. 2B. In some exemplary embodiments, the classifier may be a computer program product that is transmitted to the on-premise system. Additionally or alternatively, an executable may be retained in the on-premise system and may be provided with a prediction model in electronic form to set the prediction model of the classifier. Additionally or alternatively, the classifier may be retained in an off-premise system and may be used in a SaaS configuration to provide responses to specific anonymized queries.

Referring now to FIG. 2B showing a flowchart diagram of a method, in accordance with some exemplary embodiments of the subject matter.

On Step 260, the on-premise system may provide a second PII to the off-premise system. In some exemplary embodiments, the second PII may be a part of a second record representing a second person for which a label prediction is desired.

On Step 265, the off-premise system may obtain second enriched data, based on the second PII. Step 265 may be similar to Step 220 of FIG. 1.

On Step 270, the enriched data, which may be encrypted, may be added to the second record to create an augmented second record.

On Step 275, the on-premise system may determine a label to the second augmented record using the classifier. In some exemplary embodiments, the on-premise system may obtain the encrypted form of the enriched data of the second person from the off-premise system. The on-premise system may provide the encrypted form of the enriched data of the second person along with the sensitive data of the second record to the classifier. The classifier may be configured to decrypt the encrypted enriched data and utilize the non-encrypted form thereof for the prediction. The classifier may predict a label for the second person based on the sensitive data and the enriched data.

In some exemplary embodiments, the classifier may be provided with an anonymized second augmented record. In some exemplary embodiments, the second augmented record may be anonymized by excluding from the second augmented record the PII. The anonymized second augmented record may be considered as comprising sensitive data without the context of the associated person, and therefore such data may not be considered confidential and in breach of a desired privacy policy. As a result, in some embodiments, the classifier may be operated in an off-premise system outside the control of the organization.

The predicted label may be provided to the organization, or users thereof. The organization may make its decisions based on the predicted label. The predicted label may be provided by outputting the predicted label, such as via a screen, a display, a printout, or the like.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method performed in an environment comprising an on-premise system and an off-premise system, wherein the on-premise system retaining records, each of which comprises a personal identifying information and a data, wherein an identity of a person represented by a record is obtainable from the personal identifying information of the record, wherein the data comprising sensitive data regarding the person, wherein the identity of the person is not obtainable from the data, wherein the method comprising:
obtaining, by the on-premise system, the personal identifying information of a record representing a person;
providing at least a portion of the personal identifying information of the record to the off-premise system, wherein the off-premise system is configured to obtain enriched data associated with the person;
receiving, by the on-premise system, the enriched data from the off-premise is system; and
training a classifier using the data and the enriched data, wherein the classifier is being trained without relying on the personal identifying information.

2. The method of claim 1, further comprising:
encrypting, in the off-premise system, the enriched data to obtain an encrypted data; and
wherein said receiving comprises receiving the encrypted data, whereby the enriched data in a non-encrypted form is not obtainable by unauthorized entities within the on-premise system.

3. The method of claim 2, further comprising:
deriving, by the off-premise system, a feature from the enriched data; and
providing the feature to the on-premise system, wherein the feature is provided in a non-encrypted form.

4. The method of claim 2, wherein the on-premise system is associated with an organization, wherein the on-premise system executing entities associated with the organization, wherein the on-premise system executing entities associated with a vendor, wherein the off-premise system is associated with the vendor, and wherein entities associated with the vendor are authorized entities, wherein entities associated the organization are unauthorized entities.

5. The method of claim 2, wherein said training is performed by an authorized entity, wherein said training comprises decrypting the encrypted data, and utilizing the non-encrypted form of the enriched data in combination with the data to train the classifier.

6. The method of claim 1, further comprising:
wherein said training is performed by a second off-premise system;
in response to said training, obtaining, by the on-premise system, the classifier, wherein the on-premise system is configured to utilize the classifier to predict a label for a person.

7. The method of claim 6, wherein the second off-premise system is the off-premise system.

8. The method of claim 1, further comprising:
utilizing the classifier, by the on-premise system, to predict a label for a second person represented by a second record, wherein the second record comprising a second personal identifying information and a second data, wherein said utilizing comprises:
providing at least a portion of the second personal identifying information to the off-premise system to obtain a second enriched data;
determining, by the classifier and based on the second data and the second enriched data, the label for the second person.

9. The method of claim 1, wherein said providing the at least a portion of the personal identifying information comprises providing a proper subset of the personal identifying data.

10. The method of claim 1, wherein the off-premise system comprises a plurality of engines, each of which is configured to obtain a portion of the enriched data based on a different proper subset of the personal identifying information.

11. The method of claim 1, wherein the off-premise system is restricted from storing the personal identifying information.

12. The method of claim 1, wherein the off-premise system is configured to obtain the enriched data from publicly available information sources accessible via the Internet.

13. A computerized apparatus having a processor, wherein the apparatus retaining records, each of which comprises a personal identifying information and a data, wherein an identity of a person represented by a record is obtainable from the personal identifying information of the record, wherein the data comprising sensitive data regarding the person, wherein the identity of the person is not obtainable from the data, wherein the processor being adapted to perform the steps of:
obtaining personal identifying information of a record representing a person;
providing at least a portion of the personal identifying information of the is record to an off-premise system, wherein the off-premise system is configured to obtain enriched data associated with the person;
receiving the enriched data from the off-premise system; and
training a classifier using the data and the enriched data, wherein the classifier is being trained without relying on the personal identifying information.

14. The computerized apparatus of claim 13, wherein the processor is further adapted to perform the steps of:
encrypting, in said off-premise system, the enriched data to obtain an encrypted data; and
wherein said receiving comprises receiving the encrypted data, whereby the enriched data in a non-encrypted form is not obtainable by unauthorized entities within said computerized apparatus.

15. The computerized apparatus of claim 14, wherein the processor is further adapted to perform the steps of:
deriving, by said off-premise system, a feature from the enriched data; and
providing the feature to the computerized apparatus, wherein the feature is provided in a non-encrypted form.

16. The computerized apparatus of claim 14, wherein the computerized apparatus is associated with an organization, wherein the computerized apparatus executing entities associated with the organization, wherein said computerized apparatus executing entities associated with a vendor, wherein said off-premise system is associated with the vendor, and wherein entities associated with the vendor are authorized entities, wherein entities associated the organization are unauthorized entities.

17. The computerized apparatus of claim 14, wherein said training is performed by an authorized entity, wherein said training comprises decrypting the encrypted data, and utilizing the non-encrypted form of the enriched data in combination with the data to train the classifier.

18. The computerized apparatus of claim 13, wherein the processor is further adapted is to perform the steps of:
utilizing the classifier to predict a label for a second person represented by a second record, wherein the second record comprising a second personal identifying information and a second data, wherein said utilizing comprises:
providing at least a portion of the second personal identifying information to said off-premise system to obtain a second enriched data;
determining, by the classifier and based on the second data and the second enriched data, the label for the second person.

19. A system comprising said computerized apparatus of claim 13 and said off-premise system.

20. A computer program product comprising a non-transitory computer readable storage medium retaining program instructions, which program instructions when read by a processor, cause the processor to perform a method comprising:
obtaining, by an on-premise system, personal identifying information of a record representing a person, wherein the on-premise system retaining records, each of which comprises a personal identifying information and a data, wherein an identity of a person represented by a record is obtainable from the personal identifying information of the record, wherein the data comprising sensitive data regarding the person, wherein the identity of the person is not obtainable from the data;
providing at least a portion of the personal identifying information of the record to an off-premise system, wherein the off-premise system is configured to obtain enriched data associated with the person;
receiving the enriched data from the off-premise system; and
training a classifier using the data and the enriched data, wherein the classifier is being trained without relying on the personal identifying information.
